(19) United States
(12) Patent Application Publication
(10) Pub. No.: US 2019/0049281 A1
(43) Pub. Date: Feb. 14, 2019

(54) Fluid Level Indicating Assembly

(71) Applicant: Arthur LeCompte, Youngsville, LA (US)

(72) Inventor: Arthur LeCompte, Youngsville, LA (US)

(21) Appl. No.: 15/671,646

(22) Filed: Aug. 8, 2017

(51) Int. Cl. G01F 23/16; G01F 25/00; B62J 35/00

(52) U.S. Cl. CPC G01F 23/16; B62J 2099/002; B62J 35/00; G01F 25/0061

(57) ABSTRACT

A fuel level indicating assembly for measuring and displaying a volume of fuel in a tank includes a first housing that is configured to couple to a vehicle, such as a motorcycle, proximate to a fuel tank of the vehicle. The first housing defines an internal space. A power module, a microprocessor, and a sensor are coupled to the first housing and are positioned in the internal space. A tube is coupled to the sensor and extends from the first housing. The tube is configured to fluidically couple to a fuel line that extends from the fuel tank of the vehicle. The sensor is configured to measure a pressure of a column of fuel that is positioned in the tube and to relay the pressure measurement to the microprocessor. The microprocessor is positioned to convert the pressure measurement to the volume of the fuel in the fuel tank.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to level indicating assemblies and more particularly pertains to a new level indicating assembly for measuring and displaying a volume of fuel in a tank.

### BRIEF SUMMARY OF THE INVENTION

An embodiment of the disclosure meets the needs presented above by generally comprising a first housing that is configured to couple to a vehicle, such as a motorcycle, proximate to a fuel tank of the vehicle. The first housing defines an internal space. A power module, a microprocessor, and a sensor are coupled to the first housing and are positioned in the internal space. A tube is coupled to the sensor and extends from the first housing. The tube is configured to fluidically couple to a fuel line that extends from the fuel tank of the vehicle. The sensor is configured to measure a pressure of a column of fuel that is positioned in the tube and to relay a pressure measurement to the microprocessor. The microprocessor is positioned to convert the pressure measurement to the volume of the fuel in the fuel tank.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a fuel level indicating assembly according to an embodiment of the disclosure.

FIG. 2 is a front view of an embodiment of the disclosure.

FIG. 3 is a top view of an embodiment of the disclosure.

FIG. 4 is an in-use view of an embodiment of the disclosure.

FIG. 5 is a block diagram of an embodiment of the disclosure.

### DETAILED DESCRIPTION OF THE INVENTION

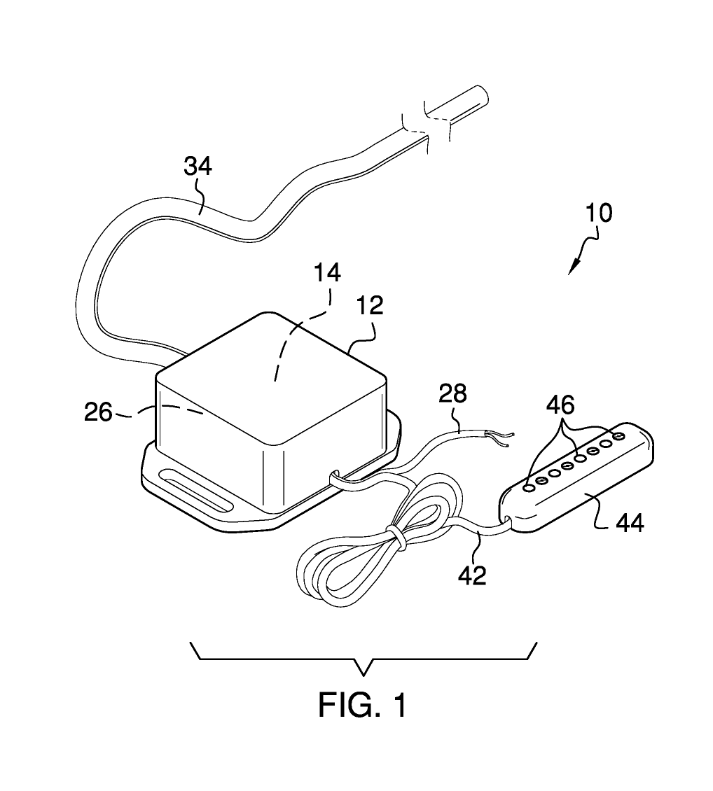

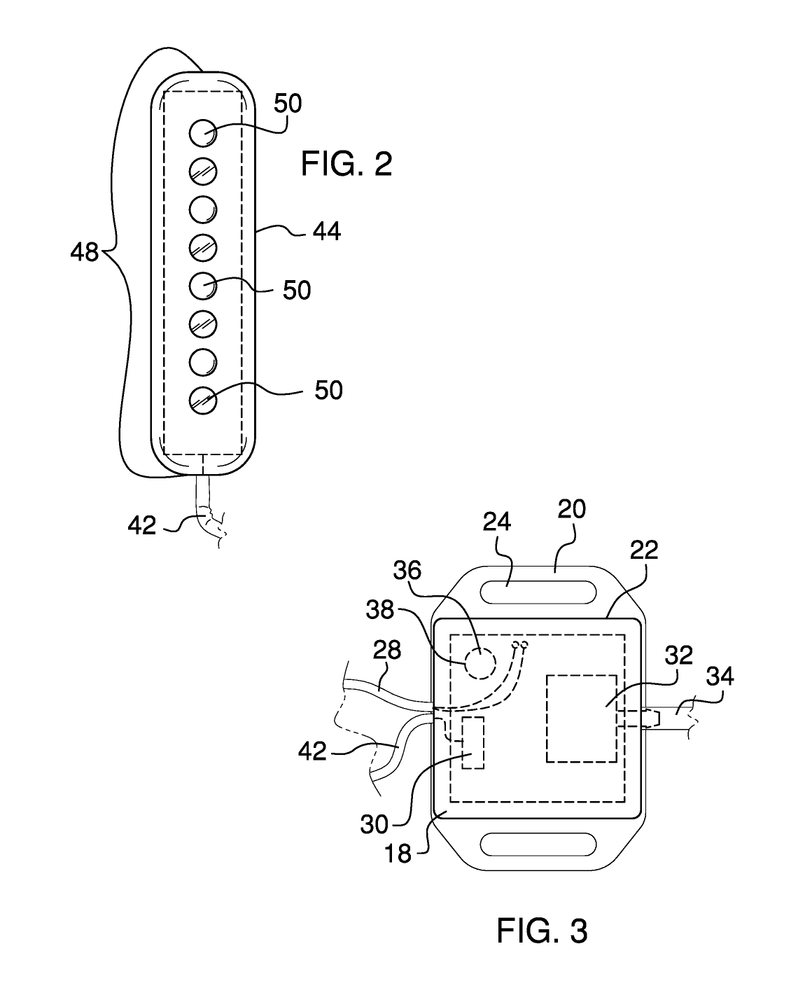

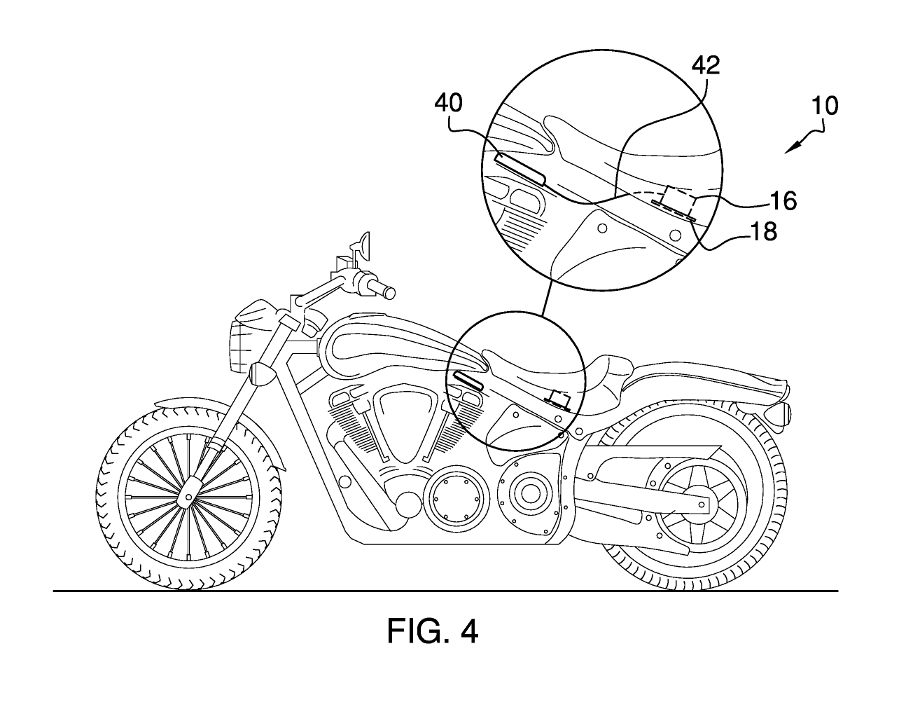

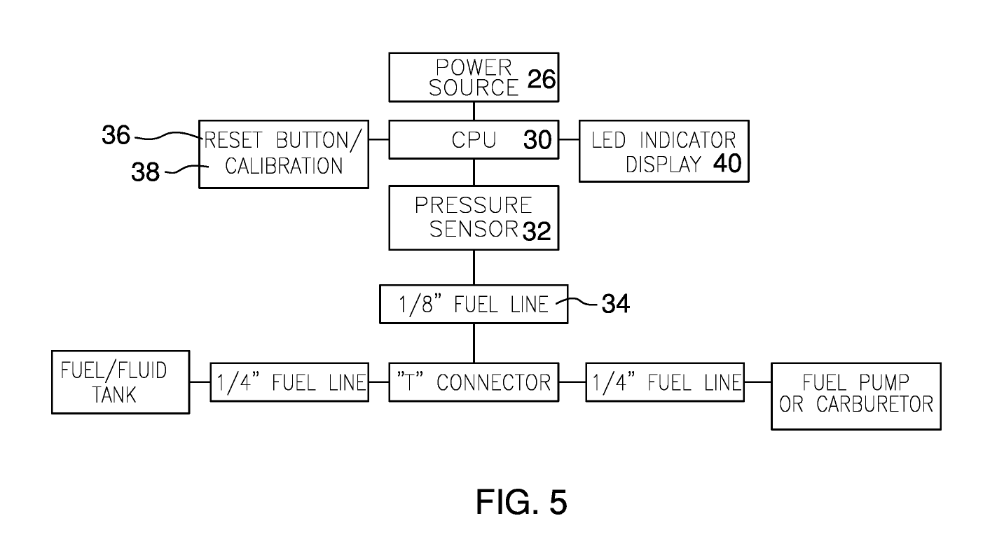

With reference now to the drawings, and in particular to FIGS. 1 through 5 thereof, a new level indicating assembly embodying the principles and concepts of an embodiment of the disclosure and generally designated by the reference numeral 10 will be described.

As best illustrated in FIGS. 1 through 5, the fuel level indicating assembly 10 generally comprises a first housing 12 that is configured to couple to a vehicle, such as a motorcycle, proximate to a fuel tank of the vehicle. The first housing 12 defines an internal space 14. In one embodiment, the first housing 12 is substantially rectangularly box shaped. In another embodiment, the first housing 12 comprises a shell 16 and a base 18. The shell 16 is reversibly couplable to the base 18 so that the internal space 14 is selectively accessible.

A pair of tabs 20 is coupled to the base 18. Each tab 20 extends from a respective opposing side 22 the base 18. Each of a pair of slots 24 is positioned through a respective tab 20. Each slot 24 is configured to insert an article of mounting hardware to couple the base 18 to the vehicle.

A power module 26 is coupled to the first housing 12 and is positioned in the internal space 14. In one embodiment, the power module 26 comprises a cord 28 that extends from the first housing 12. The cord 28 is configured to operationally couple to an electrical circuit of the vehicle.

A microprocessor 30 is coupled to the first housing 12 and is positioned in the internal space 14. The microprocessor 30 is configured to convert a pressure measurement to a volume of fuel in the fuel tank. A sensor 32 is coupled to the first housing 12 and is positioned in the internal space 14. The sensor 32 is operationally coupled to the microprocessor 30. The sensor 32 is configured to measure pressure and to relay the pressure measurement to the microprocessor 30.

A tube 34 is coupled to the sensor 32 and extends from the first housing 12. The tube 34 is configured to fluidically couple to a fuel line that extends from the fuel tank of the vehicle. The sensor 32 is configured to measure a pressure of a column of fuel that is positioned in the tube 34 and to relay the pressure measurement to the microprocessor 30. The microprocessor 30 is positioned to convert the pressure measurement to the volume of the fuel in the fuel tank.

A controller 36 is operationally coupled to the microprocessor 30. The controller 36 is configured to input commands, such a command to reset and commands to enter calibration points for an empty tank and a full tank, into the microprocessor 30. In one embodiment, the controller 36 comprises a button 38 that is coupled to the first housing 12 and is positioned in the internal space 14. The button 38 is depressible. The button 38 is configured to be depressed to compel the microprocessor 30 to reset and to enter the calibration points for the empty tank and the full tank into the microprocessor 30.

A display 40 is coupled to the first housing 12. The display 40 is operationally coupled to the microprocessor 30. The microprocessor 30 is positioned to compel the display 40 to present the volume of the fuel in the fuel tank. In one embodiment, the display 40 comprises a cable 42 that is operationally coupled to the microprocessor 30. The cable 42 extends from the first housing 12. A second housing 44 is coupled to the cable 42 distal from the first housing 12.

A plurality of bulbs 46 is coupled to the second housing 44. The bulbs 46 are operationally coupled to the cable 42. The microprocessor 30 is positioned to selectively compel the bulbs 46 to illuminate to present the volume of the fuel in the fuel tank. Each bulb 46 also is configured to illuminate intermittently in a respective pattern to indicate an associated command. Thus, the plurality of bulbs 46 is configured to illuminate intermittently in a variety of patterns to indicate a variety of associated commands. The button 38 is configured to be depressed to compel the microprocessor 30 to compel a respective bulb 46 to illuminate intermittently in the respective pattern to indicate the associated command, such as the command to enter the calibration point for the empty tank and the command to enter the calibration point for the full tank.

In another embodiment, the second housing 44 is substantially rectangularly box shaped. The second housing 44 has opposing ends 48. In yet another embodiment, the opposing ends 48 are rounded. In still yet another embodiment, each bulb 46 comprises a light emitting diode 50. In still yet another embodiment, the plurality of bulbs 46 comprises eight bulbs 46. In still yet another embodiment, the bulbs 46 are positioned linearly between the opposing ends 48 of the second housing 44.

In use, the slots 24 that are positioned in the tabs 20 so that each slot 24 is configured to insert the article of mounting hardware to couple the base 18 to the vehicle. The button 38 is configured to be depressed to compel the microprocessor 30 to compel the respective bulb 46 to illuminate intermittently in the respective pattern to indicate the associated command, such as the command to enter the calibration point for the empty tank and the command to enter the calibration point for the full tank. The sensor 32 is configured to measure the pressure of the column of the fuel that is positioned in the tube 34 and to relay the pressure measurement to the microprocessor 30. The microprocessor 30 is positioned to convert the pressure measurement to the volume of the fuel in the fuel tank. The microprocessor 30 is positioned to selectively compel the bulbs 46 to illuminate to present the volume of the fuel in the fuel tank.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fuel level indicating assembly comprising:
a first housing configured for coupling to a vehicle, such as a motorcycle, proximate to a fuel tank of the vehicle, said first housing defining an internal space;
a power module coupled to said first housing and positioned in said internal space;
a microprocessor coupled to said first housing and positioned in said internal space, said microprocessor being configured for converting a pressure measurement to a volume of fuel in the fuel tank;
a sensor coupled to said first housing and positioned in said internal space, said sensor being operationally coupled to said microprocessor, said sensor being configured for measuring pressure and for relaying the pressure measurement to said microprocessor;
a tube coupled to said sensor and extending from said first housing, said tube being configured for fluidically coupling to a fuel line extending from the fuel tank of the vehicle; and
wherein said tube is positioned on said sensor such that said sensor is configured for measuring a pressure of a column of fuel positioned in said tube and for relaying the pressure measurement to said microprocessor such that said microprocessor is positioned for converting the pressure measurement to the volume of the fuel in the fuel tank.

2. The assembly of claim 1, further including said first housing being substantially rectangularly box shaped.

3. The assembly of claim 1, further including said first housing comprising a shell and a base, said shell being reversibly couplable to said base such that said internal space is selectively accessible.

4. The assembly of claim 3, further comprising:
a pair of tabs coupled to said base, each said tab extending from a respective opposing side said base;
a pair of slots, each said slot being positioned through a respective said tab; and
wherein said slots are positioned in said tabs such that each said slot is configured for inserting an article of mounting hardware for coupling said base to the vehicle.

5. The assembly of claim 1, further including said power module comprising a cord extending from said first housing, said cord being configured for operationally coupling to an electrical circuit of the vehicle.

6. The assembly of claim 3, further including a controller operationally coupled to said microprocessor, said controller being configured for inputting commands, such a command for resetting and commands for entering calibration points for an empty tank and a full tank, into said microprocessor.

7. The assembly of claim 1, further including said controller comprising a button coupled to said first housing and positioned in said internal space, said button being depressible, wherein said button is positioned in said housing such that said button is configured for depressing for compelling said microprocessor for resetting and for entering the calibration points for the empty tank and the full tank into said microprocessor.

8. The assembly of claim 7, further including a display coupled to said first housing, said display being operationally coupled to said microprocessor, wherein said display is positioned on said first housing such that said microprocessor is positioned for compelling said display for presenting the volume of the fuel in the fuel tank.

9. The assembly of claim 8, further including said display comprising:
a cable operationally coupled to said microprocessor, said cable extending from said first housing;
a second housing coupled to said cable distal from said first housing;
a plurality of bulbs coupled to said second housing, said bulbs being operationally coupled to said cable; and
wherein said bulbs are positioned on said second housing such that said microprocessor is positioned for selectively compelling said bulbs for illuminating for presenting the volume of the fuel in the fuel tank.

10. The assembly of claim 9, further including said second housing being substantially rectangularly box shaped.

11. The assembly of claim 10, further including said second housing having opposing ends, said opposing ends being rounded.

12. The assembly of claim 8, further including each said bulb being configured for illuminating intermittently in a respective pattern for indicating an associated command such that said plurality of bulbs is configured for illuminating intermittently in a variety of patterns for indicating a variety of associated commands, wherein said button is positioned in said first housing such that said button is configured for depressing for compelling said microprocessor for compelling a respective said bulb for intermittently illuminating in the respective pattern for indicating the associated command, such as the command for entering the calibration point for the empty tank and the command for entering the calibration point for the full tank.

13. The assembly of claim 8, further including each said bulb comprising a light emitting diode.

14. The assembly of claim 8, further including said plurality of bulbs comprising eight said bulbs.

15. The assembly of claim 11, further including said bulbs being positioned linearly between said opposing ends of said second housing.

16. A fuel level indicating assembly comprising:
a first housing configured for coupling to a vehicle, such as a motorcycle, proximate to a fuel tank of the vehicle, said first housing defining an internal space, said first housing being substantially rectangularly box shaped, said first housing comprising a shell and a base, said shell being reversibly couplable to said base such that said internal space is selectively accessible;
a pair of tabs coupled to said base, each said tab extending from a respective opposing side said base;
a pair of slots, each said slot being positioned through a respective said tab, wherein said slots are positioned in said tabs such that each said slot is configured for inserting an article of mounting hardware for coupling said base to the vehicle;
a power module coupled to said first housing and positioned in said internal space, said power module comprising a cord extending from said first housing, said cord being configured for operationally coupling to an electrical circuit of the vehicle;
a microprocessor coupled to said first housing and positioned in said internal space, said microprocessor being configured for converting a pressure measurement to a volume of fuel in the fuel tank;
a sensor coupled to said first housing and positioned in said internal space, said sensor being operationally coupled to said microprocessor, said sensor being configured for measuring pressure and for relaying the pressure measurement to said microprocessor;
a tube coupled to said sensor and extending from said first housing, said tube being configured for fluidically coupling to a fuel line extending from the fuel tank of the vehicle, wherein said tube is positioned on said sensor such that said sensor is configured for measuring a pressure of a column of fuel positioned in said tube and for relaying the pressure measurement to said microprocessor such that said microprocessor is positioned for converting the pressure measurement to the volume of the fuel in the fuel tank;
a controller operationally coupled to said microprocessor, said controller being configured for inputting commands, such a command for resetting and commands for entering calibration points for an empty tank and a full tank, into said microprocessor, said controller comprising a button coupled to said first housing and positioned in said internal space, said button being depressible, wherein said button is positioned in said housing such that said button is configured for depressing for compelling said microprocessor for resetting and for entering the calibration points for the empty tank and the full tank into said microprocessor;
a display coupled to said first housing, said display being operationally coupled to said microprocessor, wherein said display is positioned on said first housing such that said microprocessor is positioned for compelling said display for presenting the volume of the fuel in the fuel tank, said display comprising:
a cable operationally coupled to said microprocessor, said cable extending from said first housing,
a second housing coupled to said cable distal from said first housing, said second housing being substantially rectangularly box shaped, said second housing having opposing ends, said opposing ends being rounded, and
a plurality of bulbs coupled to said second housing, said bulbs being operationally coupled to said cable, wherein said bulbs are positioned on said second housing such that said microprocessor is positioned for selectively compelling said bulbs for illuminating for presenting the volume of the fuel in the fuel tank, each said bulb being configured for illuminating intermittently in a respective pattern for indicating an associated command such that said plurality of bulbs is configured for illuminating intermittently in a variety of patterns for indicating a variety of associated commands, wherein said button is positioned in said first housing such that said button is configured for depressing for compelling said microprocessor for compelling a respective said bulb for intermittently illuminating in the respective pattern for indicating the associated command, such as the command for entering the calibration point for the empty tank and the command for entering the calibration point for the full tank, each said bulb comprising a light emitting diode, said plurality of bulbs comprising eight said bulbs, said bulbs being positioned linearly between said opposing ends of said second housing; and
wherein said slots are positioned in said tabs such that each said slot is configured for inserting the article of mounting hardware for coupling said base to the vehicle, wherein said button is positioned in said first housing such that said button is configured for depressing for compelling said microprocessor for compelling said respective said bulb for intermittently illuminating in the respective pattern for indicating the associated command, such as the command for entering the calibration point for the empty tank and the command for entering the calibration point for the full tank, wherein said tube is positioned on said sensor such that said sensor is configured for measuring the pressure of the column of the fuel positioned in said tube and for relaying the pressure measurement to said microprocessor such that said microprocessor is positioned for converting the pressure measurement to the volume of the fuel in the fuel tank, wherein said bulbs are positioned on said second housing such that said microprocessor is positioned for selectively compelling said bulbs for illuminating for presenting the volume of the fuel in the fuel tank.
